(19) United States
(12) Patent Application Publication
(10) Pub. No.: US 2024/0266506 A1
(43) Pub. Date: Aug. 8, 2024

(54) ELECTRODE FOR RECHARGEABLE BATTERY

(71) Applicant: SAMSUNG SDI CO., LTD., Yongin-si (KR)

(72) Inventor: Seonhyeok AN, Yongin-si (KR)

(21) Appl. No.: 18/489,759

(22) Filed: Oct. 18, 2023

(30) Foreign Application Priority Data
Feb. 6, 2023 (KR) 10-2023-0015778

(51) Int. Cl. H01M 4/36; H01M 4/131; H01M 4/62; H01M 10/0525

(52) U.S. Cl. CPC H01M 4/366; H01M 4/131; H01M 4/622; H01M 10/0525; H01M 2004/027; H01M 2004/028

(57) ABSTRACT

An electrode for a rechargeable battery includes: a substrate; and a first active material layer and a second active material layer on the substrate, the first active material layer and the second active material layer including different binders. The first active material layer and the second active material layer are on a same plane of the substrate.

### CROSS-REFERENCE TO RELATED APPLICATION

This application claims priority to and the benefit of Korean Patent Application No. 10-2023-0015778, filed in the Korean Intellectual Property Office on Feb. 6, 2023, the entire content of which is hereby incorporated by reference.

### BACKGROUND

### 1. Field

Embodiments of the present disclosure relate to an electrode, and for example, to an electrode for a rechargeable battery.

### 2. Description of the Related Art

A stacked battery cell may be formed in an order of production of a reel electrode plate by, e.g., a notching process, a sheet cutting process, stacking, and tab welding.

In the notching process and the sheet cutting process, a reel-shaped electrode plate may be disposed between a pair of upper and lower knives or molds, and the electrode plate may be formed in a form of a sheet having a desired or suitable shape by cutting by applying a strong shear force to a cutting portion to be cut.

In the cutting process, a shear force should be concentrated in a minimal or suitable region (e.g., a region as small as possible) for a short period of time without affecting periphery of the cutting portion of an object so that a defect such as detachment (or desorption), burr, and/or the like does not occur.

Concentration of the shear force depends on one or more suitable factors such as a condition of the object, e.g., tension of the electrode plate of the object to be cut, a degree of fixation of the cutting portion, and/or the like, a shape of the knife, and/or a clearance of the upper and lower knives. A quality of a cut surface may be determined by the concentration of shear force.

However, even if a condition of the process is optimized, it may not be possible to completely prevent or reduce an impact from being transferred to a vicinity of the cutting portion due to characteristics of the process, and the transferred impact can cause detachment, cracks, and/or the like of a composite material coated and rolled on a foil.

In such cases, when a detached active material is mixed, the mixed active material can cause a damage to a separator and possible ignition of the battery. In addition, the detached portion does not play a desired role of the battery, so that a shortened lifespan and a decrease in a capacity of the battery would cause deterioration in quality. Detachment of the active material may occur immediately after the cutting process, or may occur during an assembly process and a charging and discharging process.

In particular, even if the active material in a portion where the impact is transferred during the cutting process does not immediately fall (fall off or detach) due to cracking (e.g., a fine crack or cracks), the active material may be detached in a subsequent tab welding process so that the detached active material remains in the battery as a foreign (undesired) substance, or the detachment of the active material may be accelerated through impregnation of an electrolyte and/or a charging and discharging process during charging and discharging, so that a lifespan and a capacity of the battery may be reduced.

### SUMMARY

Aspects of the present disclosure are directed toward an electrode for a rechargeable battery capable of minimizing or reducing detachment of an active material during a cutting process.

Additional aspects will be set forth in part in the description which follows and, in part, will be apparent from the description, or may be learned by practice of the presented embodiments of the disclosure.

An electrode for a rechargeable battery according to one or more embodiments of the present disclosure includes: a substrate; and a first active material layer and a second active material layer that are on the substrate, the first active material layer and the second active material layer including different binders, wherein the first active material layer and the second active material layer are on a same plane of the substrate.

In one or more embodiments, the first active material layer may include a low-resistance binder, and the second active material layer may include a high adhesive binder having stronger adhesion than the low-resistance binder.

In one or more embodiments, the first active material layer may include a first lower binder layer on the substrate and including the low-resistance binder, and a first upper active material layer on the first lower binder layer, and the second active material layer may include a second lower binder layer on the substrate and including the high adhesive binder, and a second upper active material layer on the second lower binder layer.

In one or more embodiments, the first upper active material layer and the second upper active material layer may include the same binder material.

In one or more embodiments, the first lower binder layer and the second lower binder layer may further include a conductive material, and the conductive material may include at least one of denka black, carbon black, acetylene black, ketchen black, a carbon fiber, graphene, and/or a carbon nanotube (CNT).

In one or more embodiments, thicknesses of the first lower binder layer and the second lower binder layer may be less than thicknesses of the first upper active material layer and the second upper active material layer.

In one or more embodiments, the second active material layer may be around (e.g., surround) at least a portion of the first active material layer.

In one or more embodiments, a width of the second active material layer may be 0.01 mm to 0.5 mm.

In one or more embodiments, the substrate may have a form of a cut sheet, and the second active material layer may be at a region where the substrate is cut.

In one or more embodiments, the low-resistance binder may include at least one of an acryl-based binder, sodium-carboxymethylcellulose (Na—CMC), lithium-carboxymethylcellulose (Li—CMC), alginic acid derivative, chitosan derivative, polyvinyl alcohol (PVA), polyacrylic acid (PAA), polysodiumacrylate (Na—PAA), polyvinylpyrrolidone (PVP), polyacrylamide (PAAm), a vinylidene fluoride/hexafluoropropylene copolymer (P(VDF—HFP)), polyvinylidene fluoride (PVDF), polyacrylonitrile (PAN), water-borne styrene-butadiene rubber (SBR), water-borne butadiene rubber (BR), and/or a modified product thereof.

In one or more embodiments, the high adhesive binder may include water-borne styrene-butadiene rubber (SBR) and/or polyacrylic acid (PAA).

According to the embodiments of the present disclosure, it is possible to provide a high-quality battery by preventing or reducing cracking (e.g., a fine crack or cracks) and a progressive detachment of an active material from occurring in a region where a shear force transferred to a cutting portion is indirectly transferred during a forming process of a negative electrode sheet.

### BRIEF DESCRIPTION OF THE DRAWINGS

FIG. 1 is a plan view of a negative electrode according to one or more embodiments of the present disclosure.

FIG. 2 is a cross-sectional view taken along line II-II of FIG. 1, according to one or more embodiments of the present disclosure.

FIG. 3 is a view for explaining a method for cutting an electrode plate according to one or more embodiments of the present disclosure.

FIG. 4 is a cross-sectional view of an electrode for a rechargeable battery according to one or more embodiments of the present disclosure.

FIG. 5 is a exploded schematic view of a stacked electrode assembly according to one or more embodiments of the present disclosure.

### DETAILED DESCRIPTION

The present disclosure may be modified in many alternate forms, and thus specific embodiments will be illustrated in the drawings and described in more detail. It should be understood, however, that this is not intended to limit the present disclosure to the particular forms disclosed, but rather, is intended to cover all modifications, equivalents, and alternatives falling within the spirit and scope of the present disclosure.

The illustrated embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described.

Because sizes and thicknesses of constituent members shown in the accompanying drawings are provided (arbitrarily provided) for better understanding and ease of description, the present disclosure is not limited to the illustrated sizes and thicknesses.

In the drawings, the thickness of layers, films, panels, regions, etc., may be exaggerated for clarity. In the drawings, for better understanding and ease of description, thicknesses of some layers and areas are exaggeratedly displayed. Unless otherwise noted, like reference numerals denote like elements throughout the attached drawings and the written description, and thus, duplicative descriptions thereof may not be provided.

It will be understood that when an element or layer is referred to as being “on,” “connected to,” or “above” another element or layer, it can be directly on, connected to, or above the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

Spatially relative terms, such as “lower,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. The device may be otherwise oriented (e.g., rotated 90 degrees or at other orientations) and the spatially relative descriptors used herein should be interpreted accordingly.

It will be understood that, although the terms “first,” “second,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

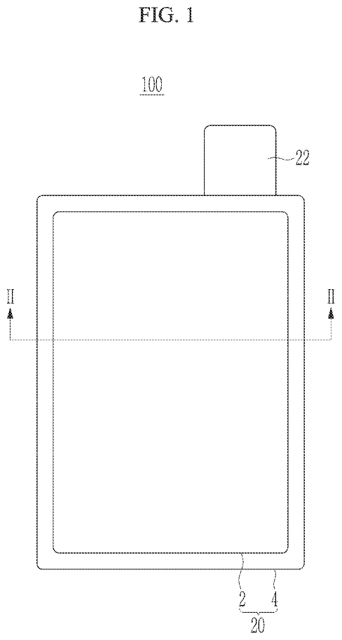

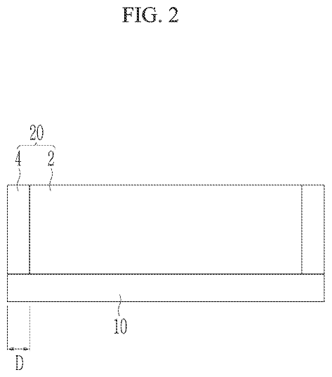

FIG. 1 is a plane view of a negative electrode according to one or more embodiments of the present disclosure, and FIG. 2 is a cross-sectional view taken along line II-II of FIG. 1, according to one or more embodiments of the present disclosure.

As shown in FIGS. 1 and 2, the negative electrode 100 according to one or more embodiments of the present disclosure includes a substrate (a basic material or a material) 10 and a negative electrode active material layer 20 formed on the substrate 10 and including a negative electrode active material.

The substrate 10 may be (e.g., may be selected from the group consisting of) a copper foil, a nickel foil, a stainless steel foil, a titanium foil, a nickel foam, a copper foam, a polymer substrate coated with a conductive metal, and/or a combination thereof.

The negative electrode active material layer 20 may be formed on one surface or both surfaces of the substrate 10 of the negative electrode 100.

The negative electrode active material included in the negative electrode active material layer 20 may be a carbon-based active material. The carbon-based active material may be artificial graphite or a mixture of artificial graphite and natural graphite. The form of the artificial graphite or the natural graphite may be amorphous, plate-like, flake, spherical, fibrous, or a combination thereof, but the present disclosure is not limited thereto and the graphite may be in any form. When the artificial graphite and the natural graphite are mixed, the mixing ratio may be 70:30 wt % to 95:5 wt %.

In one or more embodiments, the negative electrode active material layer 20 may further include at least one of a Si-based negative electrode active material, a Sn-based negative electrode active material, and/or a lithium vanadium oxide negative electrode active material. When the negative electrode active material layer 20 further includes at least one of the Si-based negative electrode active material, the Sn-based negative electrode active material, and/or the lithium vanadium oxide negative electrode active material (e.g., when the negative electrode active material layer 20 includes the carbon-based negative electrode active material that is a first negative electrode active material and a negative electrode active material that is further included in the negative electrode active material layer 20 is a second negative electrode active material), a mixing ratio of the first negative electrode active material and the second negative electrode active material may be a weight ratio of 50:50 to 99:1.

The Si-based negative electrode active material may be Si, Si—C composite, SiOₓ(0 <×<2), or a Si—Q alloy (wherein Q is an element of (e.g., selected from the group consisting of) an alkali metal, an alkaline-earth metal, a Group 13 element, a Group 14 element, a Group 15 element, a Group 16 element, a transition metal (a transition element), a rare earth element, and/or a combination thereof, and not Si), and the Sn-based negative electrode active material may be Sn, SnO₂, or a Sn—R alloy (wherein R is an element of (e.g., selected from the group consisting of) an alkali metal, an alkaline-earth metal, a Group 13 element, a Group 14 element, a Group 15 element, a Group 16 element, a transition metal (a transition element), a rare earth element, and/or a combination thereof, and not Sn). At least one of these materials may be mixed with SiO₂. The elements Q and R may be (e.g., may be selected from the group consisting of) Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and/or a combination thereof.

A content (e.g., amount) of the negative electrode active material in the negative electrode active material layer 20 may be 95 wt % to 99 wt % with respect to an entire weight of the negative electrode active material layer 20.

In one or more embodiments of the present disclosure, the negative electrode active material layer 20 may include a binder, and may optionally further include a conductive material. A content (e.g., amount) of the binder in the negative electrode active material layer 20 may be 1 wt % to 5 wt % with respect to an entire weight of the negative electrode active material layer 20. In one or more embodiments, when the conductive material is further included in the negative electrode active material layer 20, 90 wt % to 98 wt % of the negative electrode active material, 1 wt % to 5 wt % of the binder, and 1 wt % to 5 wt % of the conductive material may be utilized.

The binder serves to attach (to effectively attach) negative electrode active material particles to each other, and also serves to attach (to effectively attach) the negative electrode active material to the substrate 10 that is a current collector.

The negative electrode active material layer 20 according to one or more embodiments of the present disclosure may include a first active material layer 2 and a second active material layer 4 including different binders.

The first active material layer 2 may include a low-resistance binder, and the second active material layer 4 may include a high adhesive binder having relatively stronger adhesion than the first active material layer 2. In this case, the low-resistance binder may have weak adhesiveness compared with the high adhesive binder but may have low resistance, and conversely, the high adhesive binder may have strong adhesiveness compared with the low-resistance binder but may have high resistance.

The different binders may utilize a non-water-soluble binder, a water-soluble binder, or a combination thereof. When the water-soluble binder is utilized as the binder of the negative electrode, the binder of the negative electrode may further include a cellulose-based compound capable of imparting viscosity (e.g., that is a thickener).

For example, the low-resistance binder may include an acryl-based binder. For example, the low-resistance binder may include a cellulose-based compound such as sodium-carboxymethylcellulose (Na—CMC) or lithium-carboxymethylcellulose (Li—CMC), alginic acid derivative, chitosan derivative, polyvinyl alcohol (PVA), polyacrylic acid (PAA), polysodiumacrylate (Na—PAA), polyvinylpyrrolidone (PVP), polyacrylamide (PAAm), a vinylidene fluoride/hexafluoropropylene copolymer (P(VDF—HFP)), polyvinylidene fluoride (PVDF), polyacrylonitrile (PAN), water-borne styrene-butadiene rubber (SBR), water-borne butadiene rubber (BR), or a modified product thereof (for example, a fluorinated polymer (a polymer in which fluoride is substituted therein), a polymer with a sulfone (—SO₂—) substituent in a main chain thereof, or a copolymer thereof (for example, a random copolymer, a block copolymer, an alternating polymer with other polymers, and/or the like)). However, the present disclosure is not limited thereto, and any binder available in the art may be utilized.

The high adhesive binder may include water-borne styrene-butadiene rubber (SBR) or polyacrylic acid (PAA), and may include a compound alone or one or more compounds based on water-borne styrene-butadiene rubber (SBR) and/or polyacrylic acid (PAA).

The conductive material may be utilized to impart conductivity to the electrode, and any conductive material that does not cause a chemical change and that conducts electrons may be utilized.

The second active material layer 4 including the high adhesive binder may be disposed at an edge of the first active material layer 2 to be around (e.g., to surround) at least a portion of the first active material layer 2. As shown in FIG. 1, the second active material layer 4 may be formed to be around (e.g., to surround) the entire first active material layer 2, but the present disclosure is not limited thereto, and the second active material layer 4 may be formed only at a portion of edges of the first active material layer 2 such as upper and lower edges or left and right edges facing each other at the first active material layer 2.

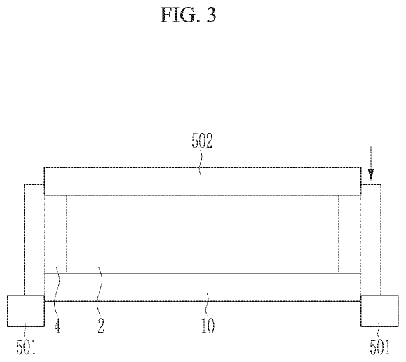

FIG. 3 is a view for explaining a method for cutting an electrode plate according to one or more embodiments of the present disclosure.

As shown in FIG. 3, according to one or more embodiments of the present disclosure, during a notching process of cutting the electrode plate produced in a form of a reel into sheets, a sheet (or a negative electrode sheet) is disposed on a die 501 and then the electrode plate is cut by a cutting blade 502 to produce the electrode. In this case, the cutting blade 502 relatively cuts the second active material layer 4 including the high adhesive binder. Thus, a cut surface is formed at the second active material layer 4.

As described above, the second active material layer 4 including the high adhesive binder is cut and the high adhesive binder is strongly attached to the substrate 10, so that even if (e.g., when) a strong impact is applied by the cutting blade, a phenomenon in which the substrate 10 is pushed or separated from the second active material layer 4 is reduced. In one or more embodiments, the second active material layer 4 including the high adhesive binder may reliably form a boundary of the first active material layer 2, and may maintain a shape of the second active material layer 4 even after the cutting impact. Thus, during the cutting, the problem of the active material being detached and/or the occurrence of a crack or cracks due to the impact of cutting may be reduced.

Because the high adhesive binder may have higher resistance than the low-resistance binder to reduce an electric characteristic of the battery, the second active material layer 4 may be formed with a minimum or suitable width that does not affect the first active material layer 2 by the cutting impact. A width D of the second active material layer 4 remaining after the cutting may be 0.01 mm to 5 mm.

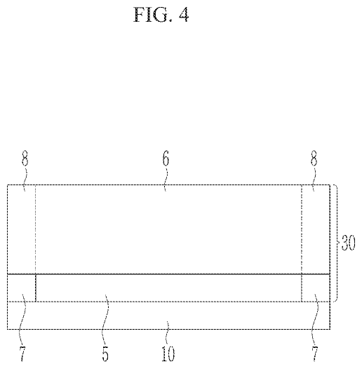

FIG. 4 is a cross-sectional view of an electrode for a rechargeable battery according to one or more embodiments of the present disclosure.

As shown in FIG. 4, the electrode for the rechargeable battery according to one or more embodiments of the present disclosure includes the substrate 10 and a negative electrode active material layer 30 formed on the substrate 10.

The negative electrode active material layer 30 includes a first lower binder layer 5 formed on the substrate 10 and including a low-resistance binder, a first upper active material layer 6 formed on the first lower binder layer 5, a second lower binder layer 7 formed on the substrate 10 and including a high adhesive binder, and a second upper active material layer 8 formed on the second lower binder layer 7.

Each of the first lower binder layer 5 and the second lower binder layer 7 may further include a conductive material in addition to the low-resistance binder or the high adhesive binder, respectively. For example, the conductive material may include at least one of denka black, carbon black, acetylene black, ketjen black, a carbon fiber, graphene, and/or a carbon nanotube (CNT).

The first upper active material layer 6 and the second upper active material layer 8 may be formed to have a thickness greater than those of the first lower binder layer 5 and the second lower binder layer 7. The first upper active material layer 6 and the second upper active material layer 8 may include different binders as in the embodiment(s) of FIG. 1, but the present disclosure is not limited thereto, and the first upper active material layer 6 and the second upper active material layer 8 may be made of an active material including the same binder.

During the cutting operation, the active material in contact with the substrate may be detached as the substrate moves down along with the cutting blade at a moment when the cutting blade cuts the substrate, but in embodiments of the present disclosure, the second lower binder layer 7 including the high adhesive binder may be disposed at a portion through which the cutting blade passes so that the substrate 10 and the upper active material layer are prevented or substantially prevented from being separated by the cutting impact or the active material is prevented or substantially prevented from being detached by the cutting impact.

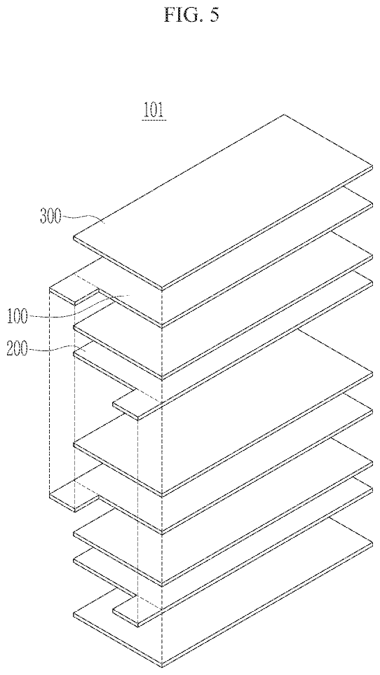

The above negative electrode sheet may be utilized in a stacked electrode assembly, and an electrode assembly according to one or more embodiments of the present disclosure will be described with reference to FIG. 5.

FIG. 5 is a schematic view of the stacked electrode assembly according to one or more embodiments of the present disclosure.

The electrode assembly 101 according to one or more embodiments of the present disclosure is the stacked electrode assembly 101 in which negative electrodes 100 and positive electrodes 200 are repeatedly stacked with a separator 300 interposed therebetween.

The separator 300 may be a polymer film that passes lithium ions, and may utilize polyethylene, polypropylene, polyvinylidene fluoride, or a multilayer film of two or more layers thereof. In one or more embodiments, the separator 300 may utilize a mixed multilayer film such as a polyethylene/polypropylene two-layered separator, a polyethylene/polypropylene/polyethylene three-layered separator, a polypropylene/polyethylene/polypropylene three-layered separator, and/or the like.

The negative electrode 100 includes an electrode portion in which an active material layer is formed at a current collector of a substrate made of copper (Cu) and an uncoated portion (or an uncoated region) in which the substrate is exposed by not applying the active material. The negative electrode 100 may be a negative electrode including the different binders as shown, for example, in FIG. 2 or 4.

The positive electrode 200 includes an electrode portion coated with an active material at a current collector of a substrate made of aluminum (Al) and an uncoated portion where the substrate is exposed by not applying the active material.

The active material of the positive electrode 200 may utilize a compound (a lithiated intercalation compound) capable of reversible intercalation and deintercalation of lithium. For example, the active material of the positive electrode 200 may utilize at least one of a composite oxide of lithium and/or a metal of (e.g., a metal selected from) cobalt, manganese, nickel, and/or a combination thereof. A content (e.g., amount) of the positive electrode active material may be 90 wt % to 98 wt % with respect to an entire weight of the positive electrode active material layer.

The positive active material layer may further include a binder and a conductive material. In this case, a content (e.g., amount) of each of the binder and the conductive material may be 1 wt % to 5 wt % with respect to the entire weight of the positive electrode active material layer.

The binder serves to attach (effectively attach) positive electrode active material particles to each other, and also serves to attach (effectively attach) the positive electrode active material to the substrate that is the current collector. A representative example of the binder may include polyvinyl alcohol, carboxymethyl cellulose, hydroxypropyl cellulose, diacetyl cellulose, polyvinyl chloride, carboxylated polyvinyl chloride, polyvinyl fluoride, a polymer including ethylene oxide, polyvinylpyrrolidone, polyurethane, polytetrafluoroethylene, polyvinylidene fluoride, polyethylene, polypropylene, a styrene butadiene rubber, an acrylated styrene-butadiene rubber, an epoxy resin, nylon, and/or the like, but the present disclosure is not limited thereto. The conductive material may be utilized to impart conductivity to the electrode, and any conductive material that does not cause a chemical change and conducts electrons may be utilized.

In one or more embodiments, a plurality of uncoated portions of the positive electrode 200 may be electrically connected to an external terminal by being electrically connected to each other, and a plurality of uncoated portions of the negative electrode 100 may be electrically connected to an external terminal by being electrically connected to each other. The uncoated portions of the positive electrode 200 and the uncoated portions of the negative electrode 100 may protrude in substantially the same direction, but the present disclosure is not limited thereto, and the uncoated portions of the positive electrode 200 and the uncoated portions of the negative electrode 100 may protrude in opposite directions and may be spaced apart from each other.

The separator 300 may be larger than the negative electrode 100 and the positive electrode 200 to protrude outside the negative electrode 100 and the positive electrode 200.

The electrode assembly 101 may be utilized as the rechargeable battery by being accommodated together with an electrolyte in a prismatic case in the form of a pouch or a can.

The electrolyte includes a non-aqueous organic solvent and a lithium salt. The non-aqueous organic solvent serves as a medium for movement of ions involved in an electrochemical reaction of the battery.

The lithium salt is a material dissolving in the organic solvent to act as a supply source of lithium ions within the battery. Thus, the lithium salt enables a basic operation of a lithium rechargeable battery, and serves to promote movement of lithium ions between the positive electrode and the negative electrode. A representative example of the lithium salt includes one or two or more of (e.g. may be one or two or more selected from the group consisting of) LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂) (wherein x and y are natural numbers, for example, an integer in a range of 1 to 20), LiCl, LiI, and/or LiB(C₂O₄)₂ (lithium bis(oxalato) borate (LiBOB)) as a supporting electrolytic salt.

The lithium salt may be utilized in a concentration in a range of 0.1 M to 2.0 M. When the lithium salt is included at the above concentration range, excellent or suitable electrolyte performance may be shown because the electrolyte has appropriate or suitable conductivity and viscosity, and the lithium ions may move effectively.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Expressions such as “at least one of,” “a plurality of,” “one of,” and other prepositional phrases, when preceding a list of elements, should be understood as including the disjunctive if written as a conjunctive list and vice versa. For example, the expressions “at least one of a, b, or c,” “at least one of a, b, and/or c,” “one selected from the group consisting of a, b, and c,” “at least one selected from a, b, and c,” “at least one from among a, b, and c,” “one from among a, b, and c”, “at least one of a to c” indicates only a, only b, only c, both a and b, both a and c, both b and c, all of a, b, and c, or variations thereof.

As used herein, the term “and/or” includes any and all combinations of one or more of the associated listed items.

As used herein, the singular forms “a,” “an” and “the” are intended to include the plural forms as well, unless the context clearly indicates otherwise.

As used herein, the term “substantially,” “about,” and similar terms are used as terms of approximation and not as terms of degree, and are intended to account for the inherent deviations in measured or calculated values that would be recognized by those of ordinary skill in the art. “Substantially” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “substantially” may mean within one or more standard deviations, or within ±30%, 20%, 10%, 5% of the stated value.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

Further, the use of “may” when describing embodiments of the present disclosure refers to “one or more embodiments of the present disclosure.”

The portable device, vehicle, and/or the battery, e.g., a battery controller, and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

Although the embodiments of the present disclosure have been described, it is understood that the present disclosure should not be limited to these embodiments, but one or more suitable changes and modifications can be made by one ordinary skilled in the art within the spirit and scope of the present disclosure as defined by the following claims and equivalents thereof.

What is claimed is:

1. An electrode for a rechargeable battery, the electrode comprising:
a substrate; and
a first active material layer and a second active material layer that are on the substrate, the first active material layer and the second active material layer comprising different binders,
wherein the first active material layer and the second active material layer are on a same plane.

2. The electrode for the rechargeable battery of claim 1, wherein the first active material layer comprises a low-resistance binder, and the second active material layer comprises a high adhesive binder having stronger adhesion than the low-resistance binder.

3. The electrode for the rechargeable battery of claim 2, wherein
the first active material layer comprises a first lower binder layer on the substrate and comprising the low-resistance binder, and a first upper active material layer on the first lower binder layer, and
the second active material layer comprises a second lower binder layer on the substrate and comprising the high adhesive binder, and a second upper active material layer on the second lower binder layer.

4. The electrode for the rechargeable battery of claim 3, wherein the first upper active material layer and the second upper active material layer comprise the same binder material.

5. The electrode for the rechargeable battery of claim 3, wherein the first lower binder layer and the second lower binder layer further comprise a conductive material, and the conductive material comprises at least one of denka black, carbon black, acetylene black, ketjen black, a carbon fiber, graphene, or a carbon nanotube (CNT).

6. The electrode for the rechargeable battery of claim 3, wherein thicknesses of the first lower binder layer and the second lower binder layer are less than thicknesses of the first upper active material layer and the second upper active material layer.

7. The electrode for the rechargeable battery of claim 2, wherein the second active material layer is around at least a portion of the first active material layer.

8. The electrode for the rechargeable battery of claim 7, wherein a width of the second active material layer is 0.01 mm to 0.5 mm.

9. The electrode for the rechargeable battery of claim 2, wherein the substrate has a form of a cut sheet, and the second active material layer is at a region where the substrate is cut.

10. The electrode for the rechargeable battery of claim 2, wherein the low-resistance binder comprises at least one of an acryl-based binder, sodium-carboxymethylcellulose (Na—CMC), lithium-carboxymethylcellulose (Li—CMC), alginic acid derivative, chitosan derivative, polyvinyl alcohol (PVA), polyacrylic acid (PAA), polysodiumacrylate (Na—PAA), polyvinylpyrrolidone (PVP), polyacrylamide (PAAm), a vinylidene fluoride/hexafluoropropylene copolymer (P(VDF—HFP)), polyvinylidene fluoride (PVDF), polyacrylonitrile (PAN), water-borne styrene-butadiene rubber (SBR), water-borne butadiene rubber (BR), or a modified product thereof.

11. The electrode for the rechargeable battery of claim 2, wherein the high adhesive binder comprises water-borne styrene-butadiene rubber (SBR) and/or polyacrylic acid (PAA).

12. A rechargeable battery comprising the electrode of claim 1.
